(19) United States
(12) Patent Application Publication
(10) Pub. No.: US 2024/0054010 A1
(43) Pub. Date: Feb. 15, 2024

(54) METHOD FOR CONTROLLING A SET OF COMPUTER BOARDS OF A MEDIA SERVER ON-BOARD AN AIRCRAFT, ASSOCIATED COMPUTER PROGRAM, ELECTRONIC CONTROL DEVICE AND MEDIA SERVER

(71) Applicant: THALES, COURBEVOIE (FR)

(72) Inventor: Nicolas FLOQUET, MERIGNAC (FR)

(21) Appl. No.: 18/259,981

(22) PCT Filed: Dec. 28, 2021
(86) PCT No.: PCT/EP2021/087749

§ 371 Date: Jun. 29, 2023

(30) Foreign Application Priority Data
Dec. 30, 2020 (FR) 2014278

(51) Int. Cl. G06F 9/48

(52) U.S. Cl. CPC G06F 9/4856; B64D 11/0015

(57) ABSTRACT

The invention relates to a method for controlling a set of computer boards of a media server intended for be carried on-board an aircraft. Each computer board is intended for executing at least one software function. The method is implemented by an electronic control device and comprises a step 200 of selection of a computer board from among the set of computer boards, a first step 220 of managing a reassignment, to one or a plurality of computer boards other than the selected board, of one or each software function pending execution by the selected board, and, following the first management step 220, a step of sending 230 a restart instruction to the selected board.

The present invention relates to a method for controlling a set of computer boards of a media server intended for being carried on-board an aircraft.

The invention further relates to a computer program comprising software instructions which, when executed by a computer, implement such a control method.

The invention further relates to a media server intended for being carried on-board an aircraft, the server comprising a set of computer boards, at least one of which is suitable for executing such a computer program.

The invention further relates to an electronic device for controlling a set of computer boards of a media server intended for being carried on-board an aircraft.

The invention then relates to the field of aircraft entertainment systems, also called an IFE (In Flight Entertainment) system which is mainly found on-board long-haul commercial aviation aircraft.

In a manner known per se, such an IFE system comprises a plurality of entertainment terminals, further called user terminals, generally in the form of individual screens or of tablets. Each entertainment terminal is integrated e.g. into the passenger seat or into the seat in front of the passenger seat.

Thus arranged, such terminals allow a passenger to consult media contents during the flight (e.g. films, TV programs, games or music) and to be informed about the course of the flight (altitude, speed, current position, progress, etc.).

In some cases, the terminals can be further used for giving certain practical information relating e.g. to the airport of arrival and for broadcasting announcements made by the crew in audio and/or video form.

The entertainment terminals are generally connected by either a wired or a wireless network, an on-board media server also being part of the IFE system.

Thereby, in order to access the computer content and implement such functions, each terminal accesses the on-board media server via the network.

Thereby, an error occurring on the media server is likely to cause an alteration of the content which, in some cases, can no longer be played via the terminals.

In the media server, it is known that such errors occur frequently. Among the errors, a common type of error is referred to as NFF (No Failure Found). Such errors are characterized by the fact that same can be corrected by an electrical restart of the media server.

However, during use, a restart of the media server cannot be considered since the operation thereof would then be stopped for some time leading, at best, to an interruption of the broadcasting of entertainment content(s) to passengers, and at worst, to an inhibition of the broadcasting of important information(s) to passengers, e.g. regarding passenger safety.

The aim of the invention is thus to propose a method for controlling a set of computer boards of a media server, an associated electronic control device and an associated computer program, used for correcting NFF errors more efficiently.

To this end, the subject matter of the invention is a method for controlling a set of computer boards of a media server intended for being carried on-board an aircraft, each computer board being intended for executing at least one software function,
the method being implemented by an electronic control device comprising:
   a step of selecting a computer board from among the set of computer boards,
   a first step of management a reassignment, to one or a plurality of computer boards other than the selected board, of one or each software function pending execution by the selected board, and
   following the first management step, a step of sending a restart instruction to the selected board.

NFF errors are often the result of malfunctions occurring in a volatile memory in the computer boards of the media server. Such malfunctions are e.g. disturbances from an isolated particle SEU (standing for Single Event Upset). Such a malfunction is likely to cause data corruption leading to random effects, ranging from immediate failure to slow propagation through the media server.

It is known that a media server in use is likely to be subject to a disturbance from an isolated particle every thousand hours of flight. Thus, such malfunctions occur several times a year for each aircraft.

The method according to the invention thus can be used for limiting the number of NFF errors by acting on the disturbances from an isolated particle affecting a media server intended for being carried on-board an aircraft.

It is then understood that the control method can be used for restarting the computer boards, thus limiting the occurrence of NFF error(s) and the propagation of disturbances from an isolated particle, while providing a continuity of the processing of the software functions.

Thereby, during such restart, the disturbances from an isolated particle, potentially present on the selected board, are eliminated during the restart of the latter.

Moreover, the control method does not disturb the transmission of content(s) between the media server and the entertainment terminals because the software functions pending execution on the selected board, are copied to the other computer boards which are apt to execute same while the selected board is restarted.

According to other advantageous aspects of the invention, the control method comprises one or a plurality of the following features, taken individually or according to all technically possible combinations:
the management step includes the sub-steps of:
   sending, to the selected board, a first instruction to copy, onto at least one other computer board, the or each software function pending execution,
   sending, to the selected board, a first instruction to delete the or each software function previously copied to at least one other computer board.
the management step also comprises, between the sub-step of sending the first instruction to copy and the sub-step of sending the first delete instruction, a sub-step of receiving from the selected board, a completion signal for the execution of each of the software functions being executed on said selected board,
the sub-step of sending the first deletion instruction being performed following the reception of the completion signal or following the expiration of a first predefined time delay, and the first deletion instruction then being an instruction for deleting all the software functions of the selected board,
after the step of transmitting a restart instruction, a second step of managing a reassignment, to the selected board, of at least one software function pending execution by a computer board other than the selected board,
the second management step includes the following sub-steps:
   issuing, towards at least one computer board other than the selected board, a second instruction to copy onto the selected board, at least one software function pending execution by said other computer board or boards, and
   issuing, towards the or each computer board other than the selected board from which a software function was copied beforehand, a second instruction to delete said software function.
between the selection step and the first management step, a step of generation of a first table from a computational need of each software function pending execution by the selected board and a computational capacity of each computer board other than the selected board; the first table associating, with each software function pending execution by the selected board, a computer board to which said software function is intended for being reassigned, and during the first management step, each software function pending execution being reassigned according to the first table.
each computer board comprising at least one processor and one random access memory, and
during the generation step, the computational capacity being determined from a quantity representative of the availability of the at least one processor and an amount of available memory of the random-access memory, and the computational need of each software function being expressed depending on said quantity and on said quantity of available memory.

The invention further relates to a computer program product including software instructions which, when executed by a computer, implement a control method as defined hereinabove.

A further subject matter of the invention is a media server intended for being carried on-board an aircraft, the media server comprising a set of computer boards, at least one of the computer boards being suitable for executing such a computer program.

According to an advantageous aspect of the invention, the media server comprises the feature according to which at least two of the computer boards include the computer program, the set of computer boards being configured for electing one of the computer boards, called master board, from among the boards including the computer program, the master board then being suitable for executing said computer program.

A further subject matter of the invention is an electronic device for controlling a set of computer boards of a media server intended for being carried on-board an aircraft,
each computer board being intended for performing at least one software function,
the electronic control device including:
   a selection module configured for selecting a computer board from the set of computer boards,
   a control module configured for controlling a reassignment, to one or a plurality of computer boards other than the selected board, of one or of each software function pending execution by the selected board, and
   a transmission module configured for sending, following the reassignment, a restart instruction to the selected board.

Such features and advantages of the invention will become clearer upon reading the following description, given only as a non-limiting example, and made with reference to the enclosed drawings, wherein:

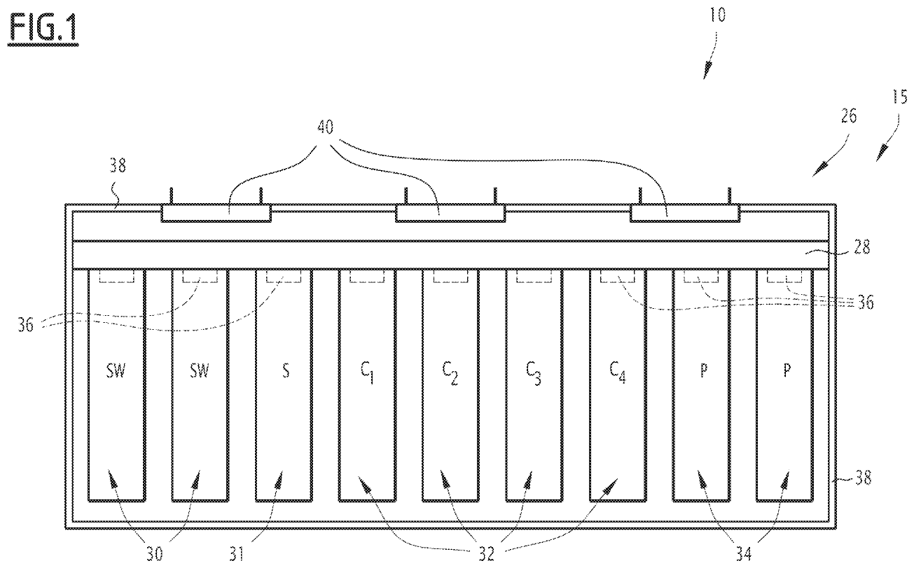

FIG. 1 is a schematic view of an electronic box forming a media server, the box including a backplane board and a plurality of electronic boards connected to the backplane board, the cabinet being carried on-board an aircraft;

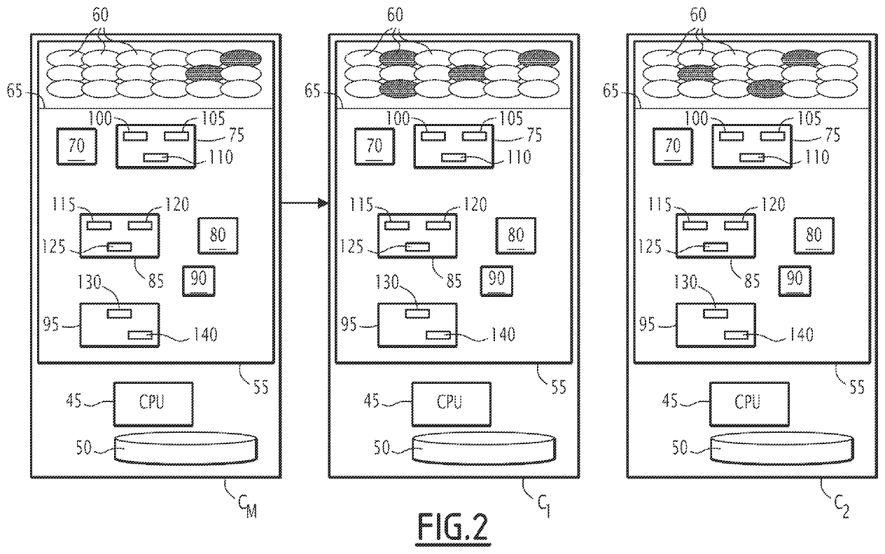

FIG. 2 is a schematic view of three computer boards comprised in the electronic box shown in FIG. 1;

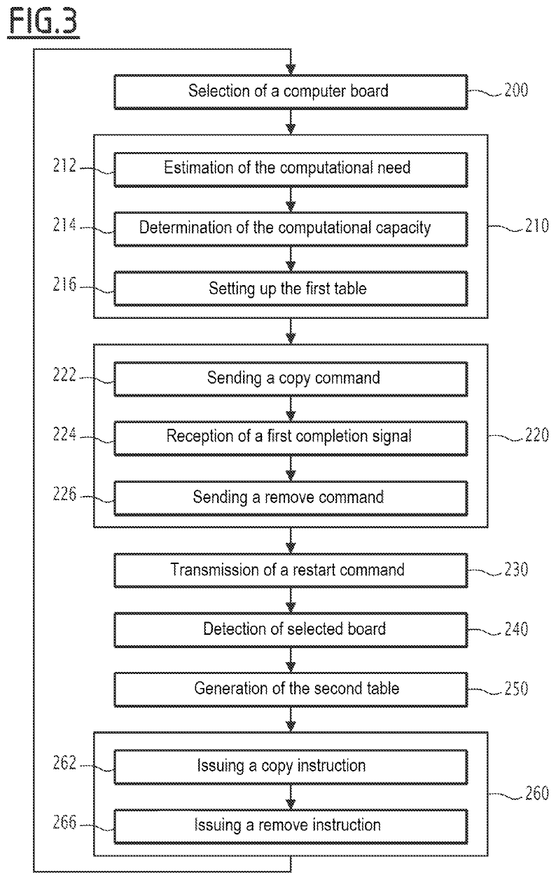

FIG. 3 is an flowchart of a control method according to the invention, the method being implemented by the control device shown in FIG. 2; and

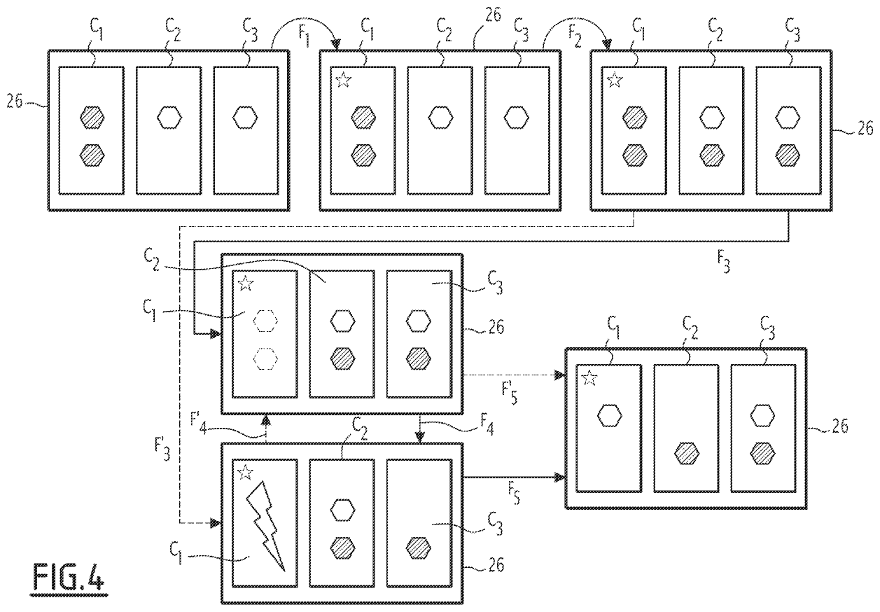

FIG. 4 illustrates the successive steps of the control method according to the invention.

FIG. 1 partially shows an aircraft 10 comprising a media server 15.

The aircraft 10 is preferentially an airplane, more particularly a commercial aviation airplane, such as a long-haul airplane. The aircraft 10 is apt to transport passengers, in particular a few dozen passengers, or even a few hundred passengers.

Each entertainment system on-board the aircraft 10 is configured for broadcasting media contents to the passengers of the aircraft 10, more particularly during the flight (e.g. movies, TV shows, games or music), and/or information on the progress of the flight (altitude, speed, current position, progress, etc.) e.g. via one or a plurality of entertainment terminals (not shown).

As an optional addition, the entertainment system is configured for broadcasting practical information about e.g. the airport of arrival, e.g. via audio and/or video announcements.

Each entertainment terminal is known per se and is connected to the media server 15 via a local network (not shown) on-board the aircraft 10.

Each entertainment terminal is e.g. attached to or integrated into the seat of the passenger, or is attached to or integrated into the backrest of the seat located in front of the seat of the passenger. The seats are typically arranged in rows within the aircraft 10.

Each entertainment terminal, also called user terminal, includes a human/machine interface HMI, a processing module, an application module and a telecommunication module. The HMI human/machine interface includes e.g. a touch-screen, or a screen and a keyboard. The application module comprises one or a plurality of application blocks. The telecommunication module includes a control block and one or a plurality of telecommunication interfaces suitable for sending and receiving data. The processing module is suitable for controlling and coordinating the operation of the application module, the human/machine interface HMI and the telecommunication module.

In one embodiment, same includes a processor and a memory, e.g. a hard disk or any other storage space apt to store digital content received in particular via the telecommunication module.

Each entertainment terminal is suitable for delivering to the passengers, the content provided by the inflight entertainment system. For example, following a selection by a passenger of a field displayed on the screen of the HMI of the entertainment terminal thereof, the processing module is suitable for identifying that a menu has to be displayed for selecting one of the applications, e.g. a list of films. Then, upon detection of the selection of a film by the passenger, the processing module is suitable for starting the display of the film on the screen. In addition to movies, the various contents can be delivered by the application: media content, e.g. movies, TV programs, games or music, flight parameters (altitude, speed, etc.) and the progress thereof (e.g. using a “moving map”), announcements (audio and/or video) made by the crew. NB EROR IN THE ORIGINAL “movie map” should read “moving map”

The screen is apt to display images corresponding to digital content broadcast from the multimedia server 15. More precisely, the digital content is received via the telecommunication module from the media server 15 in the form of a streaming or else stored in the memory of the terminal, after having been downloaded beforehand from the media server 15 via said telecommunication module.

The media server 15 is e.g. produced in the form of an electronic box 26 including a backplane board 28, a plurality of electronic boards 30, 31, 32, among which at least one network switch board 30, optionally, one or a plurality of data storage boards 31 and a plurality of computer boards 32. The server 15 further comprises one or a plurality of power supply boards 34.

Each electronic board 30, 31, 32 and each electrical power supply board 34 are each correspondingly connected to the backplane board 28 via a respective backplane connector 36, as shown in FIG. 1. The electronic box 26 further includes a protection case 38 inside which are housed the backplane board 28 and the plurality of network switch board(s) 30, of storage boards 31, of computer boards 32 and of power supply board(s) 34, and external connectors 40 arranged at the periphery of the case 38. The external connectors 40 are intended in particular for connecting the media server 15 to the on-board local network, and to an electrical power supply network carried on-board the aircraft 10.

The media server 15 preferentially comprises a plurality of boards 30, 31, 32, 34 of the same functional type chosen from the group consisting of: a network switch board 30, also denoted by SW, a data storage board 31, also denoted by S, a computer board 32, also denoted by C, and an electrical power supply board 34, also denoted by P, visible in FIG. 1. In the example shown in FIG. 1, the media server 15 comprises two network switch boards 30, one data storage board 31, four computer boards 32, and two power supply boards 34. In the example shown in FIG. 1, the computer boards 32 are arbitrarily named the first computer board C₁, the second computer board C₂, the third computer board C₃, and the fourth computer board C₄, respectively.

Advantageously, the media server 15 comprises six computer boards 32.

The local area network on-board the aircraft 10 is a wired-only network, or a partially wired and partially wireless network or further a wireless-only network.

When the on-board network is partially wireless, the media server 15 is connected e.g. by wire to an entertainment terminal of each row of seats, said terminal wired to the media server 15 then being wirelessly linked to the other terminals of the row of seats.

Each wireless link is e.g. a radio link, such as a link in line with at least one of the versions of the IEEE 802.11 standard, also called Wi-Fi™ standard, or a link conforming to the Li-Fi™ standard, e.g. with the IEEE 802.15.7 standard.

Each electronic board 30, 31, 32 has e.g. a functional type such as network switch board SW, or data storage board S, or computer board C. In other words, according to such example, each electronic board 30, 31, 32 has one functional type from the group consisting of: network switch board SW, data storage board S, computer board C.

Each network switch board 30 is configured for managing communications with the local network in a manner known per se. Each network switch board 30 is apt to switch data between the local network and the other electronic boards 31, 32, i.e. for implementing a network switching function such as Ethernet switching, according to a technique known per se and e.g. described in application FR 19 12615 filed on 12 Nov. 2019.

Among the other electronic boards 31, 32, each data storage board 31 is a board dedicated to the storage of data, in particular computer content intended for being distributed to the entertainment terminals. The data storage board 31 typically includes one or a plurality of mass storage memories.

The set of computer boards 32 is configured for electing, e.g. randomly, a master board, denoted hereafter by C_{M}, from among the set of computer boards 32. Thereby, the set of computer boards 32 comprises a master board C_{M} and three other computer boards 32. Without any loss of generality and as an example, it will be considered hereinafter in the description that the board elected as a master board C_{M} is the fourth computer board C₄.

With reference to FIG. 2, each computer board 32 comprises a central processing unit 45 or CPU, a random-access memory 50 or RAM and a data storage unit 55, such as read-only memory or ROM.

The central processing unit 45 comprises e.g. one or a plurality of processors suitable for executing tasks, also called functions.

Thus, each computer board 32 defines a volatile memory, partially included in the central processing unit 45 and in the random-access memory 50. The volatile memory stores data which can be erased whenever the board 32 is restarted.

Each read-only memory 55 is apt to store a plurality of software functions 60 suitable for being executed by the central processing unit 45.

In the example shown in FIG. 2, each software function 60 is either being executed by the respective computer board 32, i.e. by the respective central processing unit 45 of the board 32, as shown with a black fill, or pending execution by the respective computer board 32, as shown with a white fill.

Each software function 60 i e.g., a micro-service orchestrated according to a Kubernetes system from Google, Docker Swarm from Docker, Inc., or Nomad from HashiCorp.

Micro-service, or unit service, refers to a software function 60 apt to be executed independently of the other services. Thereby, such a unit service is e.g. movable from one computer board 32 to another.

Furthermore, the read-only memory 55 further comprises an electronic control device 65.

The electronic control device 65 comprises a selection module 70, a first management module 75 and transmission module 80.

Optionally, the control device 65 comprises a generation module 85, a detection module 90 and a second management module 95.

As indicated hereinabove, in the example shown in FIG. 1, the control device 65 is included in the read-only memory 55 of each computer board 32. Thereby, according to such example, the selection module 70, the management module 75, the transmission module 80, and optionally the generation module 85, the detection module 90 and a second management module 90 are each produced in the form of a software program, or a software brick, which can be executed by the central processing unit 45. The modules 70, 75, 80, 85, 90 are then stored in the read-only memory 65 in the form of a selection software, a first control software, a transmission software, and optionally a generation software, a detection software, and a second control software.

In a variant (not shown), the control device 65 is a distinct electronic device connected to each computer board 32. In a variant (not shown), the selection module 70, the first management module 75, the transmission module 80 and optionally the generation module 85 and the detection module 90 and the second management module 90 are each produced in the form of a programmable logic component, such as an FPGA (Field Programmable Gate Array), or further in the form of a dedicated integrated circuit, such as an ASIC (Application Specific Integrated Circuit).

When the electronic control device 65 is produced in the form of one or a plurality of software programs, i.e. in the form of a computer program, same is further apt of being recorded on a computer-readable medium (not shown). The computer-readable medium is e.g. a medium apt to store the electronic instructions and to be coupled to a bus of a computer system. As an example, the readable medium is an optical disk, a magneto disk, a ROM memory, a RAM memory, any type of non-volatile memory (e.g. EPROM, EEPROM, FLASH, NVRAM), a magnetic card or an optical card. A computer program containing software instructions is then stored on the readable medium.

The selection module 70 is configured for selecting a computer board C₁, C₂, C₃, or C₄ from the set of computer boards 32. The computer board 32 selected by the selection module 70 is called selected board hereinafter in the description. To this end, the selection module 70 is configured for selecting each of the computer boards 32 in turn, according to a predefined sequence repeated cyclically. Such predefined sequence is e.g. the following sequence: first computer board C₁, then second computer board C₂, then third computer board C₃, then fourth computer board C₄. Another predefined sequence would be: second computer board C₂, then third computer board C₃, then first computer board C₁, then second computer board C₂, and finally fourth computer board C₄. A person skilled in the art will recognize that it is not necessary for each computer board 32 to be selected on average the same number of times. However, the method will be all the more efficient if each computer board 32 is selected at least once.

In a variant, the selection module 70 is configured for randomly selecting one of the computer boards 32 from among the set of computer boards 32.

Without any loss of generality, as an example and with reference to FIG. 2, it is considered herein that the selected board is the first computer board C₁.

A person skilled in the art will note that the master board C_{M} can be selected by the selection module 70 and is then apt to form the selected board. Such a case where the same computer board 32 forms both the master board C_{M} and the selected board will be described hereinafter in the form of a variant.

The first management module 75 is configured for managing a reassignment, to one or a plurality of computer boards 32 other than the selected board, of one or each software function 60 pending execution by the selected board.

The first management module 75 comprises a first sending unit 100, a receiving unit 105, and a second sending unit 110.

The first sending unit 100 is configured for sending to the selected board a first instruction to copy, onto at least one computer board 32 other than the selected board, the or each software function 60 pending execution by the selected board. To this end, the first sending unit 100 is configured for sending, to the selected board, via the first instruction to copy, a first table generated by the generation module 85.

The term “instruction” is used hereinafter in the description as a synonym for the term “command”.

The first table associates with each software function 60 pending execution by the selected board, called target function, a computer board 32 other than the selected board, called target board, onto which the target function is copied.

Each computer board 32 implements an autonomous copy function, stored in the read-only memory 55, configured for copying, following the reception, via the first instruction to copy, of the first table, the or each target function, onto the target board associated in the first table.

In a variant, the first sending unit 100 is configured for sending to the selected board and for each target function of the first table, a respective first instruction to copy comprising an identifier of said target function and an identifier of the associated target board.

According to such variant, each computer board 32 then implements a unit copy function, stored in the read-only memory 55, configured for copying, following the reception, via a respective first instruction to copy, a pair of target function and target board identifiers, the or each target feature onto the associated target board.

The first sending unit 100 is also configured for sending to the selected board, an instruction to inhibit the assignment of respective software function(s) 60 to the selected board. Each computer board 32 then implements an inhibition function, stored in the read-only memory 55, configured for inhibiting, following the reception of the inhibition instruction, any new assignment(s), to the computer board 32, of the respective software function(s) 60. The name “assignment” is meant as synonymous for the name “allocation”. In other words, following the reception, by the selected board, of the inhibition instruction, any allocation to the selected board of a new respective software function 60 is prohibited.

The receiving unit 105 is configured for receiving, from the selected board, a first completion signal indicating that the execution of each software function being executed has been completed, i.e. finished.

The second sending unit 110 is configured for sending, to the selected board, a first instruction to delete the or each software function 60 previously copied onto at least one computer board 32 other than the selected board.

Each computer board 32 implements an autonomous deletion function configured for deleting, following the reception of the first deletion instruction, on its own, the or each software function 60 having been copied to another computer board 32, the deletion being performed according to the first table.

As an optional addition, the second sending unit 110 is configured for sending the first deletion instruction following the reception by the receiving unit 105, of the first completion signal, or following the expiration of a predefined time delay.

According to such optional addition, the autonomous delete feature is configured for deleting, following the reception of the first delete instruction, all software functions 60 on the selected board.

More particularly, the second sending unit 110 is configured for sending the first delete instruction following the reception of the completion signal or at the expiration of the predefined delay and the copying of each target function by the autonomous copy function. Following the reception of the first delete instruction, the autonomous delete function is then configured for deleting each target function from the selected board.

Alternatively, the second sending unit 110 is configured for sending the first deleting instruction only after the reception of the completion or the expiration of the predetermined time delay. The autonomous delete function is then configured for deleting each target function after the reception of the first deleting instruction and for copying each target function onto the respective target board.

A person skilled in the art will note that the presence of a predefined time delay is intended for preventing the control device 65 from being blocked by the execution of a respective software function 60 which would not succeed.

The transmission module 80 is configured for transmitting a restart instruction to the selected board, in particular following the sending of the first deletion instruction by the second sending unit 110.

Each computer board 32 implements a restart function configured for requesting, following the reception of the restart instruction, a restart of said computer board 32.

The term restart is understood herein the sense of an electrical restart, or of a hard reset of the respective computer board 32. In other words, during such a restart, the computer board 32 is switched off for a predefined period of time. The predefined period of time is e.g. equal to 5 seconds. Such a restart then makes it possible to ensure an erasing of all data in the volatile memory of the computer board 32. The above is particularly advantageous since disturbances from an isolated particle occur in particular within the volatile memory of the board 32.

The generation module 85 is configured for generating the first table, also called first reassignment table, associating with each software function 60 intended for being copied, a computer board 32 onto which the function 60 is to be copied. In other words, the generation module 85 is configured for generating the first table associating a respective target board with each target function. The target map is also called destination map.

Furthermore, the generation module 85 is configured for generating a second table associating a set of software functions intended for being copied onto the selected board, with each computer board 32 from which the function(s) are intended for being copied. Each computer board 32 present in the second table is also called starting board or source board. Each software function 60 present in the second table is also called source function. In other words, the second table associates with each source function intended for being copied to the selected board after the restart thereof, a respective source board from which to copy said source function.

To this end, the generation module 85 comprises a unit 115 for estimating a computational need of each software function 60 intended for being copied, a unit 120 for determining a computational capacity of each computer board 32, and a setting unit 125 configured for setting up the first table.

The estimation unit 115 is configured for estimating the computational need of each software function 60 intended for being copied, i.e. each source and target function. To this end, the estimation unit is configured for estimating, for each software function 60 pending execution, said computational need in the form of a quantifiable quantity representative of a computational capacity by a respective central processing unit 45 and of an amount of memory of the random-access memory 55, required for the performance of said function. The quantifiable quantity is e.g. expressed in flops, preferably in Mflops, Gflops or Tflops. The quantifiable quantity typically corresponds to a processor utilization rate, in particular when all the computer boards 32 have identical computational capacities. The amount of memory of the random access memory 55 is also called amount of random access memory

When each computer board 32 comprises a central processing unit 45 providing the same performance as the performance of another board 32, the utilization rate is expressed as a percentage of maximum CPU load, also called CPU fraction, i.e. a fraction of a maximum capacity of the central processing unit 45.

The amount of random-access memory available is expressed e.g. in Mbits or in Gbits.

The determination unit 120 is configured for determining the computational capacity of each computer board 32. To this end, the determination unit 120 is configured for determining the computational capacity depending on the quantifiable quantity representative of the computational capacity of each computer board 32 and of the quantity of available random-access memory of each computer board.

The setting unit 125 is configured for setting up the first table, from the computational need of each target function and the computational capacity of each target map.

To this end, the setting unit 125 is configured for associating with each target function, a target board apt to execute said function. In other words, the setting unit 125 is configured for associating with each target function, a target board the computational capacity of which is greater than the computational requirement of said target function.

Optionally, the setting unit 125 is configured for associating with each target function, a respective target board so that a computational load is distributed as homogeneously as possible among all the target boards. The computational load is understood herein in the sense of the utilization rate of the processor(s) and of the quantity of random-access memory used, of a respective computer board 32.

As an optional addition, the setting unit 125 is configured for setting up the second table, from the computational need of each software function 60 and the computational capacity of each computer board 32.

To this end, the setting unit 125 is configured for choosing, from the set of software functions 60 pending execution on the media server 15, the function or functions which are intended for being reassigned to the selected board, i.e. the source function or the source functions. To this end, the setting unit 125 is configured for choosing the source functions so that the computational load is distributed as homogeneously as possible among all the computational boards 32.

The setting unit 125 is then configured for setting up the second table by associating with each source function, the source board on which the source function is pending execution.

The detection module 90 is configured for detecting a powering-up of the selected board at the backplane board 28, following the restarting of the selected board.

The second control module 95 is configured for reassigning, following the detection of the selected board by the detection module 90, one or a plurality of respective software functions 60 to the selected board. To this end, the second management module 95 comprises a first issuing unit 130 and a second issuing unit 140.

The first issuing unit 130 is configured for sending an instruction to the selected board, for authorizing an assignment of respective new software function(s) 60. Each computer board 32 then implements an authorization function, stored in the read-only memory 55, configured for authorizing, following the reception of the authorization instruction, any new assignment(s) of respective software function(s) 60 to the computer board 32, In other words, following the reception of the authorization instruction, any new assignment to the selected board of a respective software function 60 is authorized, thus canceling the effect of the inhibition function.

The first issuing unit 130 is configured for issuing, towards at least one computer board 32 other than the selected board, a second instruction to copy onto the selected board, at least one software function 60 pending execution by said computer board(s) 32. The copy function of each computer board 32 is further configured for copying, following reception of the second instruction to copy, at least one software function 60 pending execution onto the selected board.

More particularly, the first issuing unit 130 is configured for issuing to each computer board 32 forming a respective source board, the second instruction to copy comprising the second table. Each source board is configured for executing, following the reception of the second table, via the second instruction to copy, the autonomous copy function thereof of the or each respective source function towards the selected board.

In a variant, the first issuing unit 130 is configured for issuing to each source board a respective second instruction to copy comprising an identifier of the source function and an identifier of the selected board.

Each source board is then configured for executing, following the reception of each pair of identifiers of a respective source function and of the identifier of the selected board, via the second instruction to copy, the unit copy function from the identified source function, to the selected board.

The second issuing unit 140 is configured for issuing, following the issuing of a second instruction to copy, a second deletion instruction towards each source board.

Each computer board 32 implements a unit deletion function configured for deleting, following the reception of the second deletion instruction, from the read-only memory 55 thereof, the or each software function 60 having been copied onto another computer board 32, the deletion being performed according to the second table.

More particularly, the second issuing unit 140 is configured for issuing, for each source board, the second delete instruction after the copying of each source function. Following the reception of the second delete instruction, the unit delete function of each source board is then configured for deleting each source function from the associated source board.

Alternatively, the second sending unit 140 is configured for sending, for each source board, the second deletion instruction after sending the or each second instruction to copy. After receiving the second delete instruction and copying each source function onto the selected board, the unit delete function associated with each source board is then configured for deleting each source function from each source board.

It should be noted that any instruction sent or issued from the control device 65 passes via the backplane board 28.

According to a first variant, at least two of the first sending unit 100, second sending unit 110, first issuing unit 130, second issuing unit 140 are common.

According to a second variant, compatible with the first variant, the selection module 70 is configured for selecting a new computer board 32, called newly selected board, from among the set of computer boards 32, following the detection by the detection module 90 of the powering-on of the previously selected board, called previously selected board. The previously selected and newly selected boards are then distinct. The generation module 85 is then configured for simultaneously setting up the second table associated with the previously selected board and the first table associated with the newly selected board. The first and second tables then comprise all the software functions pending execution by the newly selected board, which are each intended for being copied onto the previously selected board and already restarted. In other words, the purpose of such tables is to copy all functions pending execution by the newly selected board, onto the initially selected board, which has just been restarted.

According to a third variant, compatible with the first and second variants. The set of computer boards 32 is configured for electing, if the selection module 70 selects the previously elected master board C_{M}, a new master board from among the other computer boards 32 with the exception of the selected board.

According to a fourth variant, compatible with each of the preceding variants, the second sending unit 110 is configured for sending the second deletion instruction following the detection, by the detection module 90, of a powering-on of the selected board. In the fourth variant, the second control module 95 is configured for reassigning respective software functions 60 to the selected board, following the sending, by the second sending unit 110, of the second deletion instruction.

According to a sixth variant compatible with each of the preceding variants, the first management module 70 and the second management module 95 form a single management module.

According to a seventh variant compatible with each of the preceding variants, the second management module 95 comprises an acquisition unit (not shown) configured for acquiring, from each source board, a second completion signal when said source board has completed the execution of all the software functions currently being executed.

According to the seventh variant, the second issuing unit 140 is configured for issuing, following the acquisition of the second completion signal, the or each second deletion instruction to each source board. Each source board is then configured for performing the unitary deletion function from the second table or from the source function identifier received via the or each second deletion instruction.

The operation of the media server 15 and more particularly of the electronic control device 65, will now be described with reference to FIG. 3 representing a flowchart of a method of operation of the device 65, and with reference to FIG. 4 illustrating the effect of the method on a set of three computer boards 32.

Initially, the media server is in operation, each computer board 32 executes respective software functions 60, and comprises a certain number of software functions 60 pending execution.

With reference to FIG. 4, the media server 15 comprises four computer boards C₁, C₂, C₃, C₄, the first three of which are shown. Thereby, still with reference to FIG. 4, the first computer board C₁ comprises two software functions pending execution, each represented by a hatched hexagon. The second computer board C₂ and the third computer board C₃ each comprise a respective software function 60 pending execution, each identified by a white hexagon.

The set of computer boards 32 then elects the master board C_{M}. In the example shown in FIG. 4, and without any loss of generality, the master board C_{M} is the fourth board C₄ which is not shown in FIG. 4.

During a selection step 200, represented in FIG. 4 by the arrow F₁, the selection module 70, included in the master board C_{M}, selects a computer board 32 from among the set of computer boards 32. Without any loss of generality, in the example shown in FIG. 4, the selected board is the first computer board C₁. Same is identified by a star at the top left.

Optionally, during a first generation step 210, the generation module 85 generates the first table. To this end, the generation step 210 comprises e.g. an estimation sub-step 212, a determination sub-step 214 and a setting sub-step 216.

During the estimation sub-step 212, the estimation unit 115 estimates the computational need of each software function 60 pending execution by the selected board, also called target function, as described hereinabove.

During the determination sub-step 214, the determination unit 120 determines the computational capacity of each computer board 32 other than the selected board, also called target board. In the example shown in FIG. 4, the determination unit 120 determines the computational capacity of the master board C_{M}, of the second computer board C₂, and of the third computer board C₃.

During the setting sub-step 216, the setting unit 125 sets up the first table, from the computational need of each target function and the computational capacity of each target board, checking each time that the computational need is greater than or equal to the corresponding computational capacity.

During a first management step 220, the management module 75 manages a first reassignment, to one or a plurality of computer boards 32 other than the selected board, of one or each target function. To this end, the first management step comprises a sending sub-step 222, a reception sub-step 224 and a sending sub-step 226.

During the first sending sub-step 222, represented in FIG. 4 by the arrow F₂, the first sending unit 100 sends to the selected board, the first instruction to copy comprising the first table. The selected board then executes the autonomous copy function thereof so as to copy each of the software functions 60 thereof pending execution, to the respective target board defined according to the first table. With reference to FIG. 4, a first target function is copied to the second computer board C₂ and a second target function is copied to the third computer board C₃, each time from the selected board C₁. In FIG. 4, the first target function and the second target function copied to the second computer board C₂ and the third computer board C₃, respectively, are represented by hatched hexagons.

During the first sending sub-step 222, the first sending unit 100 also sends the instruction to inhibit the assignment of a respective new software function 60 to the selected board C₁. Following the reception of the inhibition instruction, the selected board C₁ executes the inhibition function, stored in the read-only memory 55, inhibiting any assignment, or allocation, of new respective software function(s) 60 to the selected board C₁.

During the reception sub-step 224, the reception unit 105 receives, from the selected board, the first completion signal.

During the second sending sub-step 226, represented in FIG. 4 by the arrow F₃, following the reception of the first completion signal by the reception unit 105, the second sending unit 110 sends the first deletion instruction to the selected board.

Following such sending, the selected board C₁ executes the autonomous deletion function thereof, thus deleting each target function from the read-only memory 55 thereof. In FIG. 4, each suppressed target function is represented by a hexagon, the contours of which are in dotted lines.

Then, during a transmission step 230, represented by the arrow F₄ in FIG. 4, the transmission module 80 sends the restart instruction to the selected board.

Following the reception of the restart instruction, the selected board C₁ executes the restart function thereof. After executing said function, the selected board C₁ is powered off for about five seconds. In FIG. 4, the restart is represented by a lightning bolt.

Following the restart of the selected board C₁, during a detection step 240, the detection module 90 detects the powering on of the selected board C₁. Such detection means that the selected board is no longer powered off and the restart thereof is finished.

During a second generation step 250, the generation module 85 generates the second table, as described hereinabove.

To this end, during the second generation step 250, the estimation unit 115 estimates the computational need of each software function 60. The determination unit 120 determines the computational capacity of each computer board 32. The setting unit 125 sets up the second table by choosing the or each source function so that the computational load is distributed homogeneously across the set of computer boards 32.

Then, during a second control step 260, represented in FIG. 4 by the arrow F₅, the second management module 95 drives the second reassignment, to the selected board, of at least one software function 60 pending execution by a computer board other than the selected board which has just been restarted. The second control step 260 comprises e.g. a first issuing sub-step 262 and a second issuing sub-step 266.

During the first issuing sub-step 262, the first issuing unit 130 issues, towards the selected board, the instruction to authorize the assignment of new respective software function(s). Following the reception of the authorization instruction, the selected board C₁ executes the authorization function stored in the read-only memory 55 thereof, in order to authorize any assignment, or allocation, of new respective software function(s) 60 to the selected board as such, thus canceling the effect of the inhibition function.

During the first issuing sub-step 260, the first issuing unit 130 issues the second instruction to copy comprising the second table, towards each computer board 32 other than the selected board. Following the reception of the second instruction to copy, each source board executes the autonomous copy function thereof so as to copy the source function(s) identified in the second table to the selected board which has just been restarted.

Following the issuing 262 of each second instruction to copy, during the second issuing sub-step 266, the second issuing unit 125 then issues, towards the or each computer board 32 from which at least one respective software function 60 was copied, the second delete instruction. Following the reception of the second deletion instruction, each respective computer board 32 then executes the deletion function thereof, in order to delete, from the read-only memory 55 thereof, the software function or functions 60 having been copied onto the selected board.

The method is then optionally reiterated. During the reiteration, during the selection step 200, another computer board 32 is selected. Thereby, by successive iterations of the method, each computer board 32 is restarted regularly, being used for removing the disturbances from an isolated particle.

Below are described variants of operation of the control device 65 according to the invention. The elements common between the operation of the variants and the operation described above will not be described again. Thereby, only the differences are specified in the description of said variants of operation.

According to a first variant of operation, represented in FIG. 4 by the arrows in dotted lines F₃′, F₄′ and F₅′, the second sending sub-step 226 is implemented following the detection step 240. Thereby, following the reception 224 of the first completion signal, the control device 65 moves to the transmission step 222, represented by the arrow F₃′, then to the detection step 240 and then to the second sending sub-step 226, for deleting the software functions of the selected board C₁ following the restart thereof, represented by the arrow F₄′. Following the second sending sub-step 226, the control device 65 moves to the second generation step 250, then to the second control step 260 represented by the arrow F₅′.

According to a second variant of operation (not shown), compatible with the first variant of operation, the copy of the target functions is managed by the control device 65, the selected board C₁ executing each copy of the target function towards the target board progressively as the first instructions to copy are received.

According to the second variant, during the first sending sub-step 222, the first sending unit 100 sends, to the selected board, for each target function of the first table, a respective first instruction to copy comprising the identifier of said target function and the identifier of the associated target board in the first table.

According to the second variant, the unit copy function of the selected board is configured for being executed for each target function identifier received and for each target board identifier received, in the or one of the first instructions to copy.

Similarly, according to a third variant of operation (not shown), compatible with the first and second variants of operation, the copying of the source functions is managed by the control device 65, each source board C₂, C₃ progressively executing each copying of the source function to the selected board C₁ as the second instructions to copy are received.

According to the third variant, during the first issuing sub-step 262, the first issuing unit 115 issues, for each source function of the second table, towards the associated source board, a second respective instruction to copy comprising the identifier of said source function and the identifier of the selected board.

According to the third variant, the unit copy function of each source board is configured for being executed for each source function identifier received, into the or one of the instructions to copy received.

According to the variant (not shown) wherein the second control module 95 comprises an acquisition unit, the method comprises, between the first issuing sub-step 262 and the second issuing sub-step 266, an acquisition sub-step, during which the acquisition unit acquires, from the or each computer board 32 from which a software function 60 has been copied, the second completion signal.

According to the latter variant, following the acquisition of the second completion signal, the control device 65 moves, for each source board, to the second issuing sub-step 266 during which each second deletion instruction is issued toward a respective source board, leading to the deletion of each source function of the read-only memory 55, from the respective source board.

With the method according to the invention, the selected board is thus restarted, after having copied each of the software functions 60 thereof pending execution, onto another computer board 32, which is used for deleting the disturbances from an isolated particle, or SEU, without any loss of said software function(s) 60, in order to provide uninterrupted entertainment for the IFE system user.

Furthermore, the second management step 260 is used for reassigning respective software functions 60 to the selected board following the restart thereof. Thus, the loss of computational power, due to the fact that all of the software functions 60 are momentarily distributed over a smaller number of computer boards, is temporarily very limited. Indeed, the duration of such a situation is slightly longer than the time during which the selected board is powered off, i.e. about five seconds.

It is thus easy to understand that the method according to the invention reduces the number of NFF errors by very significantly reducing the number of disturbances from an isolated particle by restarting the selected board, and preferentially due to the regular restart of each of the computer boards 32.

1. A method for controlling a set of computer boards of a media server intended for being carried on-board an aircraft,
each computer board being intended for executing at least one software function,
the method being implemented by an electronic control device and comprising:
a selection step of a computer board from among the set of computer boards,
a first management step a reassignment, to one or a plurality of computer boards other than the selected board, of one or of each software function pending execution by the selected board, and
following the first management step, a step of sending a restart instruction to the selected board.

2. The method according to claim 1, wherein the management step comprises the following sub-steps:
sending, to the selected board, a first instruction to copy, onto at least one other computer board, the or each software function pending execution,
sending, to the selected board, a first instruction to delete the or each software function previously copied to the at least one other computer board.

3. The method according to claim 2, wherein the management step further comprises, between the sub-step of sending the first instruction to copy and the sub-step of sending the first delete instruction, a sub-step of reception from the selected board, of a completion signal for the execution of each of the software functions being executed on said selected board,
the sub-step of sending the first deletion instruction being performed following the reception of the completion signal or following the expiration of a first predefined time delay, and the first deletion instruction then being an instruction to delete all the software functions of the selected board.

4. The method according to claim 1, further comprising, after the step of transmission of a restart instruction, a second step managing a reassignment, to the selected board, of at least one software function pending execution by a computer board other than the selected board.

5. The method according to claim 4, wherein the management step further comprises the following sub-steps:
issuing, towards at least one computer board other than the selected board, a second instruction to copy onto the selected board, at least one software function pending execution by said computer board(s), and
issuing, toward the or each computer board other than the selected board from which a software function has been previously copied, a second instruction to delete said software function.

6. The method according to claim 1, further comprising, between the selection step and the first step of managing a step of generation of a first table from a computational requirement of each software function pending execution by the selected board and [determining] a computational capacity of each computational board other than the selected board; the first table associating, with each software function pending execution by the selected board, a computer board to which said software function is intended for being reassigned, and
during the first management step, each software function pending execution is reassigned according to the first table.

7. The method according to claim 6, wherein each computer board comprises at least one processor and a random-access memory, and
during the generation step, the computational capacity is determined from a quantity representative of the availability of the at least one processor and an amount of available memory of the random-access memory, and the computational need of each software function being expressed depending on said quantity and on said quantity of available memory.

8. A computer program including software instructions which, when executed by a computer, implement a method according to claim 1.

9. A media server intended for being carried on-board an aircraft, the media server comprising a set of computer boards, at least one of the computer boards being suitable for executing the computer program according to claim 8.

10. The media server according to claim 9, wherein at least two of the computer boards include the computer program according to claim 8, the plurality of computer boards being configured for electing one of the computer boards, called master board, among the boards including the computer program, the master board then being suitable for executing said computer program.

11. An electronic control device of a set of computer boards of a media server intended for being carried on-board an aircraft,
each computer board being intended for executing at least one software function,
the electronic control device comprising:
a selection module configured for selecting a computer board from the set of computer boards,
a management module configured for managing a reassignment, to one or a plurality of computer boards other than the selected board, of one or each software function pending execution by the selected board, and
a transmission module configured for sending, following the reassignment, a restart instruction to the selected board.
